(19) United States
(12) Patent Application Publication
(10) Pub. No.: US 2014/0046884 A1
(43) Pub. Date: Feb. 13, 2014

(54) APPARATUS, METHOD, AND PROGRAM FOR EXTRACTING CONTENT-RELATED POSTS

(71) Applicant: KDDI CORPORATION, Tokyo (JP)

(72) Inventors: Maike Erdmann, Saitama (JP); Tomoya Takeyoshi, Saitama (JP); Chihiro Ono, Saitama (JP)

(73) Assignee: KDDI CORPORATION, Tokyo (JP)

(21) Appl. No.: 13/960,174

(22) Filed: Aug. 6, 2013

(30) Foreign Application Priority Data
Aug. 8, 2012 (JP) 2012-175986

(51) Int. Cl. G06N 99/00

(52) U.S. Cl. CPC G06N 99/005
USPC 706/20

(57) ABSTRACT

To achieve accurate classification of posts into related and unrelated ones in a short time and at low cost by performing automatic data labeling in supervised learning. An apparatus for extracting content-related posts, including a microblog collection section that collects posts by using an API provided by the microblog, a classification section that classifies titles into titles having multiple meanings and titles not having multiple meanings, and a microblog relevance determination section that determines the relevance of posts to content depending on whether the title has multiple meanings.

### TECHNICAL FIELD

The present invention relates to an apparatus, a method, and a program that extract posts related to content having a title (such as TV program, book, and movie) from microblog posts while excluding posts unrelated thereto.

### BACKGROUND ART

A microblog such as Twitter is a popular medium to share information and opinions on content (hereinafter, referred to merely as “content”) having a title, such as a TV program, a book, or a movie. Analyzing microblog posts related to the content is of great value for content producers and broadcasters in estimating popularity of the content, as well as for content viewers in obtaining recommendations for content that suits their interest.

However, since many content titles are ambiguous (i.e., have multiple meanings) like “Supernatural”, “Once upon a time”, or “The Big Bang Theory”, extraction of all microblog posts containing a title of content faces the problem that many posts unrelated to the content are extracted. For example, assuming that the title of content is “Lost”, there can be a post “I am watching Lost”, that is related to the content and a post “I think lost my wallet”, that is unrelated to the content.

Thus, in order to improve the accuracy of the extraction of content-related posts, a few attempts have been made using supervised machine learning that extracts features from a set of manually labeled posts (Non-patent Documents 1 to 3). Some of the attempts are aiming at extracting a company name (e.g., “Apple”, “Target”), but can be easily applied to the content extraction.

Another approach uses unsupervised machine learning (Non-patent Documents 4 and 5). This approach extracts features from external resources such as Web pages in order to classify posts into related and unrelated ones. Yet another approach uses manually calculated thresholds rather than machine learning to classify the posts (Non-patent Document 6).

### CITATION LIST

### Non Patent Literature

[Non Patent Literature 1]O. Dan, J. Feng, B. Davison: A Bootstrapping Approach to Identifying Relevant Tweets for Social TV, ICWSM Poster, 2011

[Non Patent Literature 2]S. Zhang, J. Wu, D. Zheng, Y. Meng, Y. Xia, H. Yu: Two Stages Based Organization Name Disambiguity, CICLing, 2012

[Non Patent Literature 3]S. R. Yerva, Z. Miklos, K. Aberer: Entity-based Classification of Twitter Messages, IJCSA Journal, 2012

[Non Patent Literature 4]F. Perez-Tellez, D. Pinto, J. Cardiff P. Rosso: On the Difficulty of Clustering Microblogging Texts for Online Reputation Management, ACL-HLT Workshop, 2011

[Non Patent Literature 5]M. Yoshida, S. Matsushima, S. Ono, I. Sato, H. Nakagawa: ITC-UT: Tweet Categorization by Query Categorization for On-line Reputation Management, CLEF Workshop, 2010

[Non Patent Literature 6]S. Wakamiya, R. Lee, K. Sumiya: Towards Better TV Viewing Rates: Exploiting Crowd's Media Life Logs over Twitter for TV Rating, IC UIMC, 2011

### SUMMARY OF INVENTION

### Technical Problem

However, although the supervised learning process described in Non-patent Documents 1 to 3 can classify posts into related and unrelated ones quite accurately, manual data labeling is very time consuming and expensive. Besides, it is unclear whether a classifier created based on a limited number of contents can be applied to posts having different content titles.

The unsupervised learning described in Non-patent Documents 4 and 5 and threshold based approaches described in Non-patent Document 6 are both likely to achieve a lower accuracy than supervised machine learning. Besides, they can be quite complex due to the need to collect and process data from various external resources.

An object of the present invention is therefore to provide an apparatus, a method, and a program for extracting content-related posts that perform automatic data labeling for supervised learning to allow accurate classification of posts into related and unrelated ones in a short time and at low cost.

### Solution to Problem

In order to achieve the objective, one of a feature of the present invention is that the apparatus for extracting content-related posts comprises a microblog collection section that collects posts by using an API provided by a microblog, a classification section that classifies titles of posts into titles having multiple meanings and titles not having multiple meanings, and a microblog relevance determination section that determines the relevance of posts to content depending on whether the titles in the posts have multiple meanings.

Another feature of the present invention further comprises a classifier building section that builds a classifier to be used in the microblog relevance determination section, wherein the classifier building section includes a training data labeling section that uses titles not having multiple meanings to extract a set of posts related to the content and a set of unrelated posts from all microblog posts, then creates labeled training data, a basic feature extraction section that extracts features for the classifier that estimates whether a post is related to content, and a basic classifier building section that builds a basic classifier from the features by evaluating the features using the training data.

Another feature of the present invention further comprises a classifier building section that builds a classifier to be used in the microblog relevance determination, wherein the classifier building section includes an extended feature extraction section that extracts extended features each indicating a high possibility of being related to content, and an extended classifier building section that evaluates training data built by the basic classifier to build an extended classifier from the extended features.

It is preferred that the extended feature extraction section further extracts extended features each indicating that a content title is more likely to be used in a different context.

It is preferred that the titles having multiple meanings have characteristics, each word in the title exists in a dictionary, the title contains three or less words, and articles containing the title exist in an online encyclopedia.

It is preferred that the set of posts related to content is a set of posts each containing a title not having multiple meanings, and the set of posts unrelated to content is a set of posts obtained by excluding, from a set of randomly extracted posts, posts containing a title not having multiple meanings and terms related to content.

It is preferred that the basic classifier building section divides the training data into multiple data groups, sets one of the data groups and the remaining data groups as test data and training data, respectively, performs cross-validation for data refinement, and evaluates the refined training data, to rebuild a basic classifier.

The present invention includes a method of extracting content-related posts comprising a microblog collection step of collecting posts by using an API provided by the microblog, a classification step of classifying titles into titles having multiple meanings and titles not having multiple meanings, and a microblog relevance determination step of determining the relevance of posts to content depending on whether each of the titles has multiple meanings.

The present invention includes a program allowing a computer to extract content-related posts, that functions as a microblog collection section that collects posts by using an API provided by the microblog, a classification section that classifies titles into titles having multiple meanings and titles not having multiple meanings, and a microblog relevance determination section that determines the relevance of posts to content depending on whether each of the titles has multiple meanings.

### Advantageous Effects of Invention

With the present invention, it is easily possible to distinguish content-related microblog posts from unrelated posts in a short time and at low cost even for contents with ambiguous titles. The related posts can then be used to analyze accurately what viewers are thinking about given content. This analysis data is invaluable for producers and broadcasters of contents, if they want to respond to the needs of their viewers. Apart from that, the data can be used in order to recommend contents to the viewers.

### BRIEF DESCRIPTION OF DRAWINGS

FIG. 1 is a function configuration diagram of the apparatus of the present invention;

FIG. 2 is a flowchart of the process in which the apparatus of the present invention extracts content-related posts;

FIG. 3 is a flowchart of the process performed by the title classification section;

FIG. 4 is a flowchart of the process performed by the microblog relevance determination section;

FIG. 5 is a flowchart of the process in which a classifier is built; and

FIG. 6 is a flowchart of the process in which a basic classifier is built.

### DESCRIPTION OF EMBODIMENT

An embodiment of the present invention will be described in detail below with reference to the drawings. Although a description for the extraction of posts related to a TV program in the present embodiment will be given, the present invention can be applied to the extraction of not only posts related to TV programs but also posts related to other contents having a title, such as a book or a movie.

Hereinafter, content having a title, such as a TV program, a book or a movie, is referred to merely as “content”.

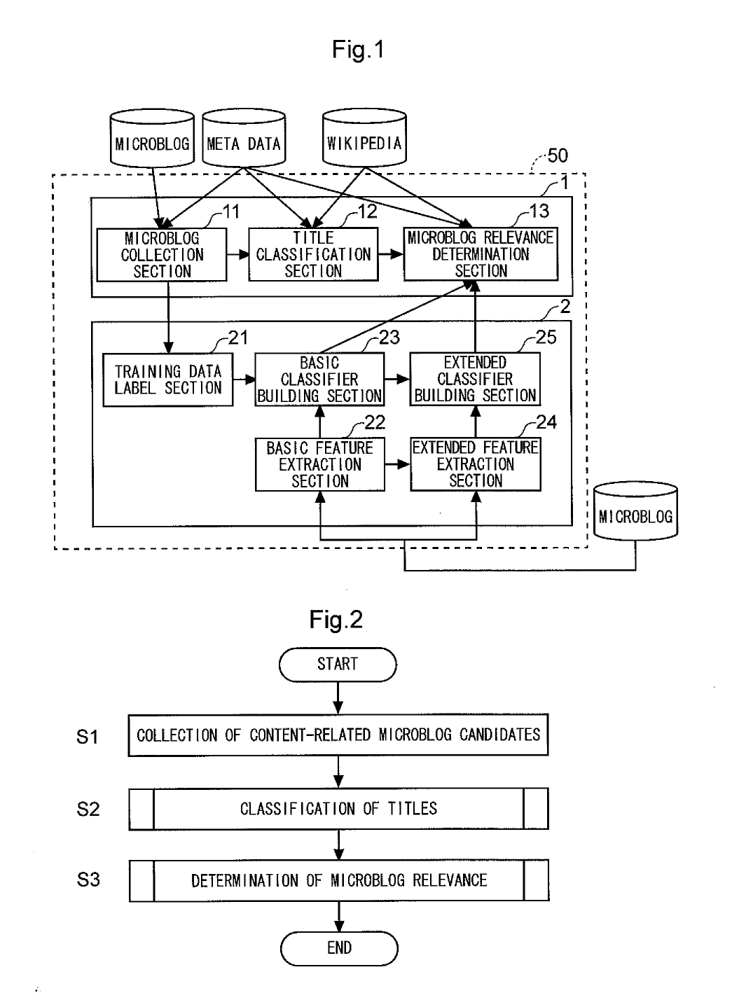

FIG. 1 is a function configuration view of an apparatus of the present invention. The apparatus 50 of the invention includes a content-related post extraction section 1 and a classifier building section 2. The content-related post extraction section 1 includes a microblog collection section 11, a title classification section 12, and a microblog relevance determination section 13. The classifier building section 2 includes a training data label section 21, a basic feature extraction section 22, a basic classifier building section 23, an extended feature extraction section 24, and an extended classifier building section 25. In the content-related post extraction section 1, collected posts are classified by a basic classifier or an extended classifier built in the classifier building section 2 into post related to a TV program and post unrelated thereto. In the present embodiment, supervised learning is employed. However, as automatic labeling of SNS (microblog) posts is performed, cost for labeling is reduced.

The content-related post extraction section 1 is a section that receives the titles of the posts as input and extracts content-related posts. The microblog collection section 11 collects the posts using an API or the like provided by the microblog. The title classification section 12 classifies the input titles into ambiguous titles (titles having multiple meanings) and non-ambiguous titles (titles not having multiple meanings). The microblog relevance determination section 13 uses the classifier built in the classifier building section 2 to determine whether each post is relevant to the content depending on whether the title thereof has multiple meanings.

The classifier building section 2 is a section that builds the classifier. The training data label section 21 uses titles not having multiple meanings to perform automatic labeling of the posts for building the classifier to classify the posts into two sets: a set of posts related to a TV program and a set of posts unrelated thereto, and thereby creates training data. The basic feature extraction section 22 extracts features for the basic classifier. The basic classifier building section 23 builds the basic classifier based on the features extracted by the basic feature extraction section 22. The extended feature extraction section 24 extracts, for the extended classifier, features related to the titles each having multiple meanings. The extended classifier building section 25 builds the extended classifier based on the features extracted by the extended feature extraction section 24.

FIG. 2 is a flowchart of the process in which the apparatus of the present invention extracts the content-related posts. Hereinafter, the operation of the content-related post extraction section 1 will be described in detail according to the flowchart.

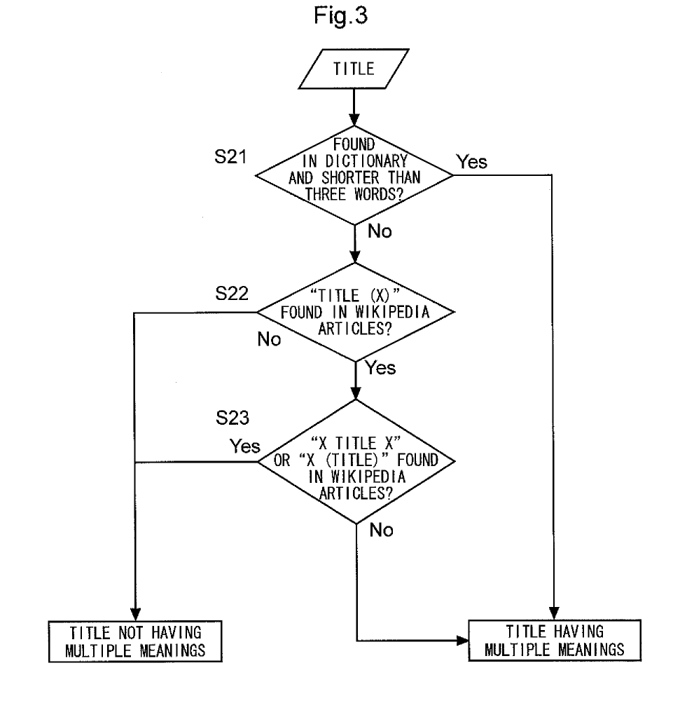

In step 1, an API or the like provided by the microblog is used to collect the posts. In step 2, the titles are classified into ambiguous titles (titles having multiple meanings) and non-ambiguous titles (titles not having multiple meanings). The presence/absence of multiple meanings of each title is determined by three steps, as illustrated in flowchart of FIG. 3. FIG. 3 is a flowchart of the process performed by the title classification section 12. In the process shown in the flowchart of FIG. 3, it is determined whether or not the title has multiple meanings.

In step 21, it is checked whether each word in the title is contained in a dictionary (e.g. a spell check dictionary). If this is the case, we assume that the title has multiple meanings. However, when the title consists of three or more words, the title is considered as not having multiple meanings even if all the words are contained in the dictionary. This is because with an increasing number of words, the chance decreases that the whole string is used in a different context. Examples are titles such as “Attack of the show” and “How I met your mother”.

In step 22, it is checked whether any Wikipedia (online encyclopedia to which anybody can add articles and content) articles of the form “Title (X)” exist. Examples are “Heroes (comics)” and Glee (music). If this is not the case, we assume that the title does not have multiple meanings. On the other hand, if this is the case, the processing flow proceeds to step 23. In this case, we assume that the title can have different meanings, such as a book title or the name of a song because it cannot be considered at this stage that the title does not have multiple meanings.

In step 23, it is checked whether articles of the form “X Title X” or “X (Title)” exists in Wikipedia. Examples of the former are “List of Glee episodes” and “Characters of Supernatural” and examples of the latter are “Mark Sloan (Grey's Anatomy)” and “If Tomorrow Never Comes (Grey's Anatomy)”. If we find such articles in Wikipedia, it is considered that the title does not have multiple meanings.

Thus, only when the title is determined to not exist in the dictionary and to be not short (step 21) and to not have multiple meanings from Wikipedia (steps 22 and 23), it is determined to be unambiguous (not to have multiple meanings).

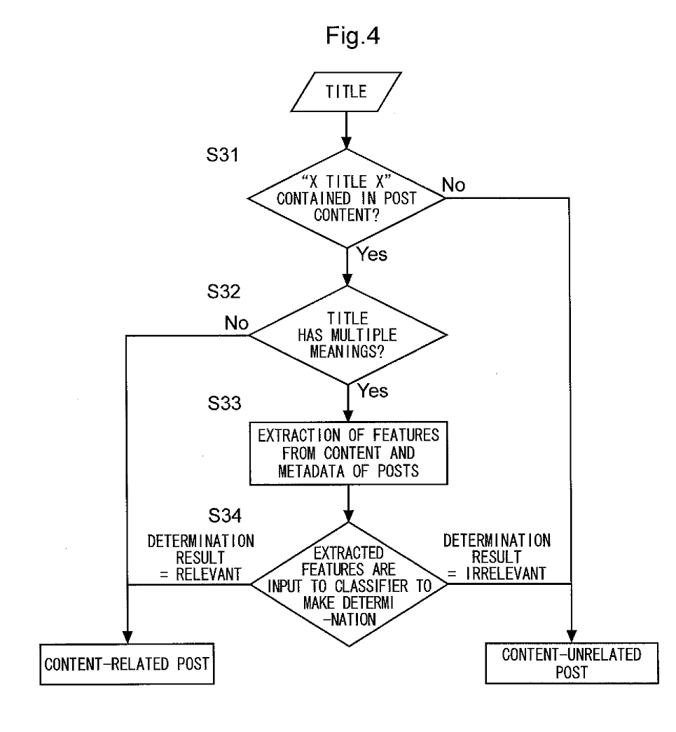

In step 3 in FIG. 2, microblog relevance is determined. FIG. 4 is a flowchart of the process performed by the microblog relevance determination section 13. Whether or not a microblog post is a post related to the content title is determined by the flowchart of FIG. 4.

In step 31, it is determined whether the string “X Title X” is contained in the content of the post. If this is not the case, the post is determined to be unrelated to the content. If this is the case, the processing flow proceeds to step 32.

In step 32, it is determined whether the title has multiple meanings. If this is not the case, the microblog post is determined to be related to the content. On the other hand, if it is the case, the processing flow proceeds to step 33.

In step 33, a number of features are extracted from the content and meta data of the post.

In step 34, the features extracted in step 33 are inputted to the classifier built in the classifier building section 2 so as to determine whether the microblog post is related to the content. If the determination result is “relevant”, the microblog post is determined to be related to the content; if the determination result is “irrelevant”, the microblog post is determined to be unrelated to the content.

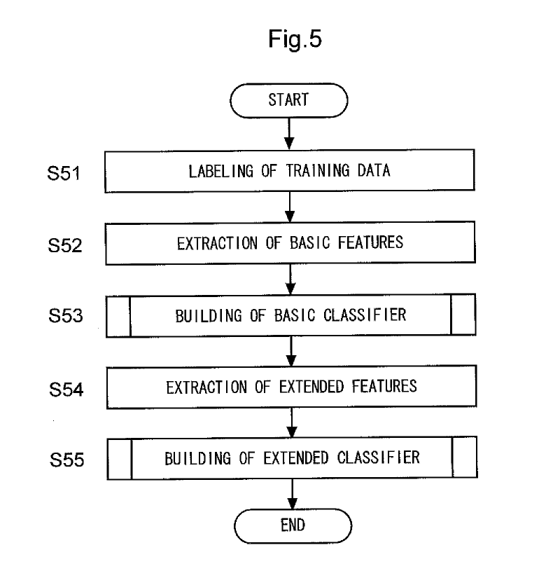

FIG. 5 is a flowchart of the process in which the classifier is built.

In step 51, training data is labeled. For building the classifier, two sets of labeled posts are extracted from a large number of posts: one is a set (positive examples) of the posts related to the TV program; and the other is a set (negative examples) of the posts unrelated to the TV program.

As positive examples, posts having TV program titles not having multiple meanings are extracted. However, the posts having titles containing strings of the form “X title X” are removed if these strings are titles of Wikipedia articles. The reason for this is that if a title in the post is substring of a longer title, it is more likely to be related to the longer title than to the shorter title (e.g., “Lost” and “The Lost World”).

Subsequently, as negative examples, posts are randomly extracted from the microblog. However, the posts having titles containing TV-related terms such as TV program titles not having multiple meaning or other typical keywords (e.g. watching) are removed, to make sure that no TV-related posts are contained.

In step 52, features for the basic classifier are extracted. That is, various features for the classifier that estimates whether the post is related to the TV program are extracted according to methods described in Non-patent Documents 1 to 3. For example, the following features 1 and 2 are extracted for each post.

Feature 1: Does the post contain terms and expressions in a list of TV-related terms and expressions? The list is a list of terms and expressions extracted from the positively labeled posts. The reason for extracting feature 1 is that the more TV related terms a post contains, the more likely it is related to the TV program.

Feature 2: How large is the word overlap between the post text and information found in external resources such as TV program guides or Wikipedia (e.g. TV program description, list of actors, list of characters)? The reason for extracting feature 2 is that if there is a large overlap between words in the post and words in external resources, the post is more likely related to the TV program.

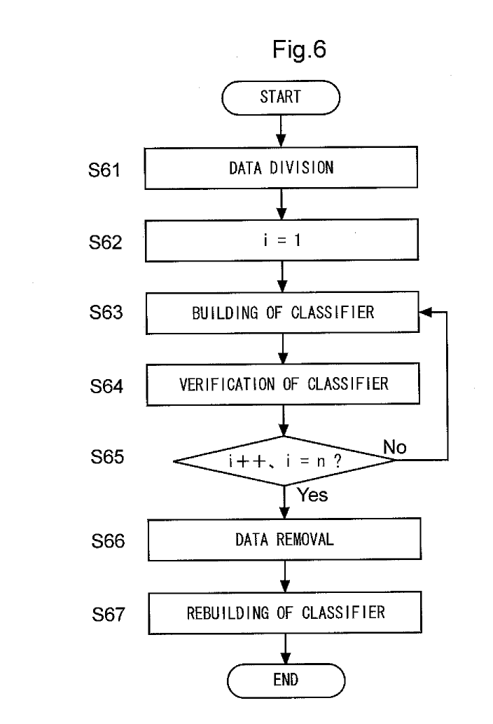

In step 53, the basic classifier is build. After extraction of all features, the training data created in step 51 is cross-validated for data refinement, whereby training data with low confidence is removed. Then, the basic classifier is built from the refined training data. FIG. 6 is a flowchart of the process in which the basic classifier is built.

In step 61, the data is divided. That is, the training data is divided into n (integer equal to or larger than 2, e.g., 10 to 20) parts.

In step 62, i is set to 1.

In step 63, the classifier is build. Data other than the i-th data set are used as the training data to build the classifier using machine learning (e.g., SVM).

In step 64, the built classifier is verified. The i-th data is used as test data, and the features of the i-th data is inputted to the classifier built in step 63 to acquire a result (estimated label and confidence) for the i-th data.

In step 65, i is incremented, and steps 63 and 64 are repeated until i=n.

In step 66, data is removed. After the results for the n data are acquired by the n cross validations, data with low confidence is removed from the n data for data refinement.

In step 67, the classifier is rebuilt. That is, the remaining data is used to build the training data. The classifier is rebuilt using the built training data using machine learning (e.g., SVM).

After that, posts containing TV program titles having multiple meanings but that are yet unlabeled are prepared, and the prepared posts are labeled using the basic classifier. Then, after data with low confidence is removed from the posts, training data for the extended classifier is built.

In step 54, features for the extended classifier are extracted. The classification results for the TV program titles having multiple meanings are analyzed and are used to extract more features. That is, various basic features for the classifier are extracted according to methods described in Non-patent Documents 1 to 3. For example, the following features 3 to 6 are extracted for each post.

Feature 3: Are TV program titles in the post capitalized? The reason for extracting feature 3 is that if the title is capitalized, the post is more likely to be related to the TV program.

Feature 4: Are other TV program titles present in the post? The reason for extracting feature 4 is that if other TV program titles are present in the post, the post is more likely to be related to the TV program.

Feature 5: Does the post contain terms and expressions in the list of terms and expressions extracted from related posts? The reason for extracting feature 5 is that the more TV related terms a post contains, the more likely it is related to the TV program.

Feature 6: Does the post contain terms and expressions in a list of terms and expressions typically extracted from unrelated posts? The reason for extracting feature 6 is that the more typically unrelated terms a post contains, the less likely it is related to the TV program.

In addition, the following features 7 to 12 are added. By adding these features, the classifier can be biased towards labeling posts as related, if the features indicate that the number of related posts is high. Conversely, if the features indicate that the number of related posts is low, the classifier can be biased towards labeling posts as unrelated. As opposed to the features used in Non-patent Documents 1 to 3, the values of the proposed features in the present invention are identical for all posts extracted for the same TV program titles.

Feature 7: How many or what percentage of words constituting the TV program title exist in the dictionary? The reason for extracting feature 7 is that the more the words contained in the title are found in the dictionary, the more likely the TV program title can be used in different contexts.

Feature 8: How many words are contained in the TV program title? The reason for extracting feature 8 is that a TV program title containing many words is less likely used in different contexts.

Feature 9: How frequently are the words in the TV program title used in everyday language? This determination is made based on a word frequency list. The reason for extracting feature 9 is that the more frequently the words in the TV program title are used in everyday language, the more likely the TV program title can be used in other contexts.

Feature 10: How many Wikipedia articles in the form “X (Title)” are matched? The reason for extracting feature 10 is that a TV program title matching many Wikipedia articles of the form “X (Title)” is more likely to be used in different contexts.

Feature 11: How many Wikipedia articles in the form “X Title X” are matched? The reason for extracting feature 11 is that a TV program title matching many Wikipedia articles of the form “X Title X” is more likely to be used in different contexts.

Feature 12: What percentage of incoming links of all Wikipedia articles containing the TV program title lead to the article referring to the TV program? The reason for extracting feature 12 is that if Wikipedia articles containing the TV program title but not describing the TV program have a large percentage of incoming links, the TV program title is more likely used in different contexts.

In step 55, the extended classifier is built. With the above additional features, the extended classifier is built from the training data. If desired, the steps of removing training data with low classification confidence, adding more unlabeled training examples, extracting more features, and rebuilding the classifier can be repeated several times.

The embodiment described above is merely illustrative and not restrictive, and the present invention may be implemented in various modifications and alterations. Thus, the scope of the present invention is limited only by the claims and the equivalents thereof.

### REFERENCE SIGNS LIST

1 . . . content-related post extraction section
2 . . . classifier building section
11 . . . microblog collection section
12 . . . title classification section
13 . . . microblog relevance determination section
21 . . . training data label section
22 . . . basic feature extraction section
23 . . . classifier building section
24 . . . extended feature extraction section
25 . . . extended classifier building section
50 . . . apparatus for extracting content-related posts

What is claimed is:

1. An apparatus for extracting content-related posts, comprising:
a microblog collection section that collects posts by using an API provided by a microblog;
a classification section that classifies titles of posts into titles having multiple meanings and titles not having multiple meanings; and
a microblog relevance determination section that determines relevance to content of posts depending on whether the title of a post has multiple meanings.

2. The apparatus for extracting content-related posts according to claim 1, further comprising a classifier building section that builds a classifier to be used in the microblog relevance determination section, wherein the classifier building section includes:
a training data labeling section that uses said titles not having multiple meanings to extract, from all microblog posts, a set of posts related to content and a set of unrelated posts, then creates labeled training data;
a basic feature extraction section that extracts features for a classifier that estimates whether a post is related to content; and
a basic classifier building section that builds a basic classifier from the features by evaluating the features using the training data.

3. The apparatus for extracting content-related posts according to claim 1, further comprising a classifier building section that builds a classifier to be used in the microblog relevance determination section, wherein the classifier building section includes:
a training data labeling section that uses the titles not having multiple meanings to extract, from all microblog posts, a set of posts related to content and a set of unrelated posts, then creates labeled training data;
a basic feature extraction section that extracts features for a classifier that estimates whether a post is related to content;
a basic classifier building section that builds a basic classifier from the features by evaluating the features using the training data;
an extended feature extraction section that extracts extended features each indicating a high possibility of being related to content; and
an extended classifier building section that evaluates training data built by the basic classifier to build an extended classifier from the extended features.

4. The apparatus for extracting content-related posts according to claim 3, wherein the extended feature extraction section further extracts extended features each indicating that a content title is more likely to be used in other contexts.

5. The apparatus for extracting content-related posts according to claim 1, wherein the titles having multiple meanings have characteristics, which words constituting each title exist in a dictionary; whether the title contains three or less words;
and whether articles in an online encyclopedia exist containing the title.

6. The apparatus for extracting content-related posts according to claim 2, wherein said set of posts related to content is a set of posts each containing title not having multiple meanings, and
said set of posts unrelated to content is a set of posts obtained by excluding, from a set of randomly extracted posts, posts each containing said title not having multiple meanings and a term related to content.

7. The apparatus for extracting content-related posts according to claim 2, wherein the basic classifier building section divides the training data into multiple data groups, set one of the data groups and the remaining data groups as test data and training data, respectively, performs cross-validation for data refinement, and evaluates the refined training data, to rebuild a basic classifier.

8. A method of extracting content-related posts, comprising:
a microblog collection step of collecting posts by using an API provided by a microblog;
a classification step of classifying titles into titles having multiple meanings and titles not having multiple meanings; and
a microblog relevance determination step of determining relevance of posts to content depending on whether the title has multiple meanings.

9. A program allowing a computer that extracts content-related posts to function as:
a microblog collection section that collects posts by using an API provided by a microblog;
a classification section that classifies titles into titles having multiple meanings and titles not having multiple meanings; and
a microblog relevance determination section that determines the relevance of posts to content depending on whether the title has multiple meanings.
